(19) United States
(12) Patent Application Publication
(10) Pub. No.: US 2026/0016825 A1
(43) Pub. Date: Jan. 15, 2026

(54) SYSTEMS AND METHODS FOR VEHICLE POSE-BASED UNMANNED AERIAL VEHICLE CONTROL

(71) Applicant: Toyota Motor Engineering & Manufacturing North America, Inc., Plano, TX (US)

(72) Inventor: John-Michael McNew, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/770,778

(22) Filed: Jul. 12, 2024

(51) Int. Cl. G05D 1/24; G05D 1/689; G05D 105/80; G06T 7/70

(52) U.S. Cl. CPC G05D 1/24; G05D 1/689; G06T 7/70; G05D 2105/89; G06T 2207/30252

(57) ABSTRACT

Systems, methods, and other embodiments described herein relate to capturing images of a vehicle from a vehicle-connected unmanned aerial vehicle (UAV) based on the pose of the vehicle. A method includes receiving a selection of a predetermined position around the vehicle for the UAV operatively connected to the vehicle. The method also includes positioning the UAV at the predetermined position to capture images of a target feature of the vehicle. The method also includes determining a pose of the vehicle and orienting the UAV relative to the vehicle based on the pose of the vehicle. The method also includes setting an operating parameter of a camera of the UAV based on the pose of the vehicle.

### TECHNICAL FIELD

The subject matter described herein relates, in general, to capturing images of a vehicle from a vehicle-connected unmanned aerial vehicle (UAV) and, more particularly, to capturing images of the vehicle based on the pose of the vehicle.

### BACKGROUND

Vehicles are a practical tool that quickly and comfortably transport people across great distances. Vehicles can transport people and/or cargo across an extensive network of roads, thus facilitating economic and social connections between communities that are otherwise largely separated. Vehicles in various forms (e.g., personal vehicles, public transport buses, and cargo-hauling tractors and trailers) are commonplace in many locations across the globe and used by tens of millions of people daily.

Since their introduction, vehicles have also been used as a source of recreation. For example, automobile races can be found in most countries across the globe and are popular with motorists and spectators alike. As another example, vehicles may be used in off-road environments where an individual navigates a vehicle over uneven, rocky, muddy, steep, and otherwise difficult-to-navigate terrain. Navigating across this terrain and around the obstacles and features found thereon may be complex, but it is also a source of enjoyment for many people.

### SUMMARY

In one embodiment, example systems and methods relate to a manner of improving the capture of vehicle images from a vehicle-connected unmanned aerial vehicle (UAV).

In one embodiment, a UAV control system for capturing vehicle pose-based images of the vehicle is disclosed. The UAV control system includes one or more processors and a memory communicably coupled to the one or more processors. The memory stores instructions that, when executed by the one or more processors, cause the one or more processors to 1) receive a selection of a predetermined position around a vehicle for a UAV operatively connected to the vehicle and 2) position the UAV at the predetermined position to capture images of a target feature of the vehicle. The memory also stores instructions that, when executed by the one or more processors, cause the one or more processors to 1) determine a pose of the vehicle, 2) orient the UAV relative to the vehicle based on the pose of the vehicle, and 3) set an operating parameter of a camera of the UAV based on the pose of the vehicle.

In one embodiment, a non-transitory computer-readable medium for capturing vehicle pose-based images of the vehicle is disclosed and including instructions that, when executed by one or more processors, cause the one or more processors to perform one or more functions is disclosed. The instructions include instructions to 1) receive a selection of a predetermined position around a vehicle for a UAV operatively connected to the vehicle and 2) position the UAV at the predetermined position to capture images of a target feature of the vehicle. The instructions also include instructions to 1) determine a pose of the vehicle, 2) orient the UAV relative to the vehicle based on the pose of the vehicle, and 3) set an operating parameter of a camera of the UAV based on the pose of the vehicle.

In one embodiment, a method for capturing vehicle pose-based images of the vehicle is disclosed. In one embodiment, the method includes 1) receiving a selection of a predetermined position around a vehicle for a UAV operatively connected to the vehicle and 2) positioning the UAV at the predetermined position to capture images of a target feature of the vehicle. The method also includes 1) determining a pose of the vehicle, 2) orienting the UAV relative to the vehicle based on the pose of the vehicle, and 3) setting an operating parameter of a camera of the UAV based on the pose of the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an environment in which the UAV control system controls a UAV to capture vehicle pose-based images of the vehicle.

FIG. 2 illustrates one embodiment of a vehicle within which systems and methods disclosed herein may be implemented.

FIG. 3 illustrates a UAV control system interacting with a UAV and vehicle to control the UAV to capture vehicle pose-based images of the vehicle.

FIG. 4 illustrates one embodiment of the UAV control system that is associated with controlling the UAV to capture vehicle pose-based images of the vehicle.

FIG. 5 illustrates one embodiment of a human-machine interface (HMI) of the vehicle to control the UAV.

FIG. 6 illustrates one embodiment of the UAV control system controlling the UAV to capture vehicle pose-based images of the vehicle.

FIG. 7 illustrates a flowchart for one embodiment of a method that is associated with controlling the UAV to capture vehicle pose-based images of the vehicle.

### DETAILED DESCRIPTION

Systems, methods, and other embodiments associated with improving image capture of the exterior of a vehicle are disclosed herein. As described above, vehicles are used daily by many of the world's inhabitants. In some cases, vehicles are used recreationally to navigate terrain with obstacles and features that block the path of the vehicle. These trails may still be navigated, provided the driver follows a particular path to maneuver around the obstacles. If not correctly maneuvered around, such obstacles and features may cause damage to the vehicle and/or injure a passenger or bystander. For example, a large boulder may be in front of a vehicle. If the driver approaches the boulder too fast or at the wrong angle, the boulder may damage certain vehicle components. Those components on the undercarriage of the vehicle, such as axles, drivetrains, gearboxes, etc., that are closest to the ground are particularly susceptible to damage resulting from ground/obstacle contact.

Accordingly, the present specification describes a UAV that is operatively connected to the vehicle and captures images of the exterior of the vehicle. The images may be transmitted to a human-machine interface (HMI) in the vehicle to provide visual information about the surroundings of the vehicle to a passenger or driver within the vehicle. In one particular example, the UAV is controlled via the HMI to capture images of those regions of the vehicle particularly susceptible to ground contact, i.e., the undercarriage region, as the vehicle navigates terrain where features/obstacles are likely to collide with the vehicle. In this example, the UAV control system may alter or turn off certain UAV control parameters, such as a ground clearance metric. For example, a default UAV minimum hover height may be three feet above the ground. However, to facilitate image capture of the undercarriage of the vehicle, it may be desirable for the UAV to fly closer to the ground, for example, from 6-12 inches.

In a particular example, a user selects, via the HMI, a predetermined position around the vehicle for the UAV. The UAV flies to this position and is oriented to capture images of a portion of the vehicle associated with the predetermined position. For example, a user may instruct the UAV to move to the driver-side of the vehicle, near the driver-side front wheel. In this example, the UAV may fly to this location and hover low to the ground to provide images/video of the undercarriage (e.g., the axles of the vehicle) in this region and any nearby obstacles.

In a particular example, the orientation of the UAV relative to the vehicle is based on the pose of the vehicle. That is, rather than simply tracking the longitude and latitude position of the vehicle and providing tracking-based images/video streams, the UAV control is further based on the angular rotations (e.g., yaw, pitch, and roll) of the vehicle. For example, if a vehicle has a roll angle such that the passenger side of the vehicle is higher than the driver side, a field of view of the axle from the front driver-side corner of the vehicle may be blocked by the body of the vehicle. In this example, the UAV control system may re-orient the UAV or direct the UAV to another location around the vehicle to provide a better field of view of the axle.

In another example, a vehicle may be traveling up an incline. In this example, a UAV in front of and level with the vehicle may be unable to capture a front view of the vehicle's undercarriage because of the inclined ground surface. Accordingly, in this example, the UAV control system may change the hover height of the UAV as well as the angle of the camera based on the detected pitch of the angle such that the UAV can capture front-view images of the undercarriage of the vehicle even when the vehicle is pitched upward.

The present specification also describes an HMI through which user control over the UAV is provided. Through the HMI, a user may select the predetermined position/target feature that the UAV is to capture images of and may further manually alter the position of the UAV relative to the predetermined position to provide a desired field of view of the vehicle and/or the target feature of the UAV that the user would like to see. In one particular instance, the HMI presents digital representations of the vehicle and a set of predetermined positions around the vehicle where the UAV may be positioned. That is, the HMI may display the position of the UAV relative to the vehicle.

In this way, the disclosed systems, methods, and other embodiments may improve vehicular navigation, particularly on roads with obstacles/features that could damage the vehicle. The UAV control system provides a view of the surroundings of the vehicle and particular target features of the vehicle, such as vehicle undercarriage components, without requiring the driver to exit the vehicle and without relying on an individual outside of the vehicle, i.e., a “spotter” to instruct the driver. Such a spotter may be exposed to risk by being in proximity to the vehicle and the potential for obstacles/debris to be thrown toward the individual by the vehicle wheels. As such, a driver can navigate the terrain with a clear view of the obstacle/feature. When the driver exits the vehicle to observe an obstacle or relies on instructions from a spotter, the driver cannot simultaneously see the obstacle and navigate the vehicle around the obstacle. In some cases, exit from the vehicle may not be possible or may pose a significant risk of injury.

Moreover, the UAV control system facilitates the image capture of a target feature of a vehicle based on the pose of the vehicle to ensure that a clear view of the target feature is provided to an HMI of the vehicle. Without such a pose-based image capture, the target feature and/or the obstacle that could potentially damage the vehicle may not be visible or out of the field of view of the driver. Still further, the present system provides an HMI where the vehicle operator can readily guide the UAV in a manual, semi-autonomous, or autonomous mode to provide relevant images of a target region of the vehicle.

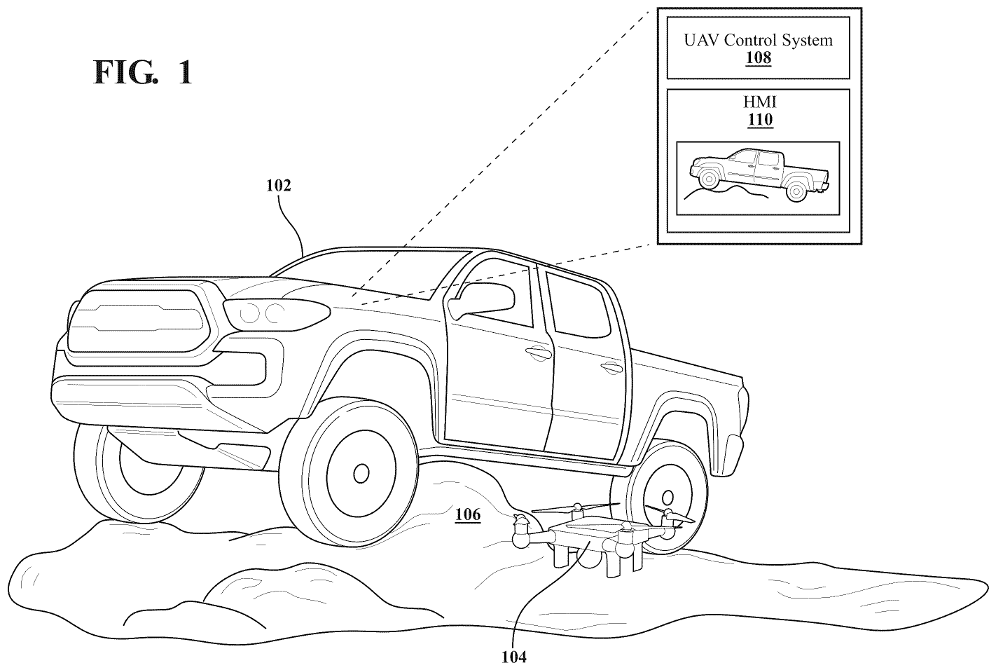

FIG. 1 illustrates an environment in which the UAV control system 108 controls a UAV 104 to capture vehicle pose-based images of the vehicle 102. As used herein, a “vehicle” is any form of transport that may be motorized or otherwise powered. In one or more implementations, the vehicle 102 is an automobile. While arrangements will be described herein with respect to automobiles, it will be understood that embodiments are not limited to automobiles. In some implementations, the vehicle 102 may be a robotic device or a form of transport that benefits from the functionality discussed herein associated with capturing images of the vehicle 102 and obstacles in the environment of the vehicle 102.

As described above, it may be the case that a vehicle 102, whether intentionally as a form of recreation or out of necessity when traveling to a remote location, encounters roads/trails where objects on the road/trail can cause damage to the vehicle 102. For example, as depicted in FIG. 1, a vehicle 102 may navigate a path strewn with boulders 106 and other debris. Some obstacles may be large enough to strike and collide with vehicle components. Those components on the underside of the vehicle 102, such as the vehicle frame, axles, gearboxes, and drive trains, may be particularly susceptible to collision and resulting damage. For example, as a vehicle 102 front tire rises on top of a boulder 106 and then falls off the other side, the downward force of the vehicle 102 may cause the boulder 106 to bend, break, or damage a component on the underside of the vehicle 102 on the down strike. When such contact occurs in a remote location, a passenger may be in a dangerous situation away from aid and potentially in a location without communication support. While particular reference is made to one scenario, other scenarios may exist where a driver wants a view of the exterior surroundings.

Accordingly, the UAV control system 108 includes components to control a UAV 104 to navigate around the vehicle 102 to capture images of a target feature of the vehicle 102, such as the undercarriage of the vehicle 102. Specifically, through a UAV control system 108, a user can instruct the UAV 104 to fly to a particular location around the vehicle 102, which particular location provides a view of the target feature of the vehicle 102. The UAV 104 flies to this location, orients itself such that a camera of the UAV 104 is pointed towards the vehicle/target feature, captures images/video stream of the vehicle and/or target feature, and transmits such back to a display of an HMI 110 of the vehicle 102. Thus, the present UAV control system 108 displays the surroundings of the vehicle 102 on a display within the vehicle 102. A driver may rely on these images/video streams to safely navigate the obstacles on the trail. Accordingly, the UAV control system 108 allows the driver to navigate the obstacles (e.g., boulder 106) cautiously to prevent or reduce the likelihood of vehicle 102 damage.

In one particular example, the UAV 104 may be operable in different “modes,” and a user may select a mode for the UAV 104. In a “spotter” mode as described herein, where the UAV 104 is to hover/fly around the vehicle 102, the UAV 104 may be controlled to fly low to the ground to provide a clear view of obstacles in the vicinity of the undercarriage of the vehicle 102. In this example, height is one example of a flight parameter of the UAV 104 controlled by the UAV control system 108, with the height being selected based on the operating mode of the UAV 104.

In an example, certain flight parameters of the UAV 104 may be altered and/or disabled. For example, in other modes, the UAV 104 may have a minimum hover height parameter where the UAV 104 is prohibited from flying/hovering within a threshold distance, e.g., 3 feet, from the ground. However, in the spotter mode, this minimum hover height parameter may be altered or disabled to allow the UAV 104 to fly closer to the ground to provide a closer view of the obstacle, e.g., the boulder 106. That is, the boulder 106 may not be visible when certain minimum hover height parameters are enforced. Accordingly, while in spotter mode, the UAV 104 may be allowed to fly closer to the ground to provide a clear view of the obstacle.

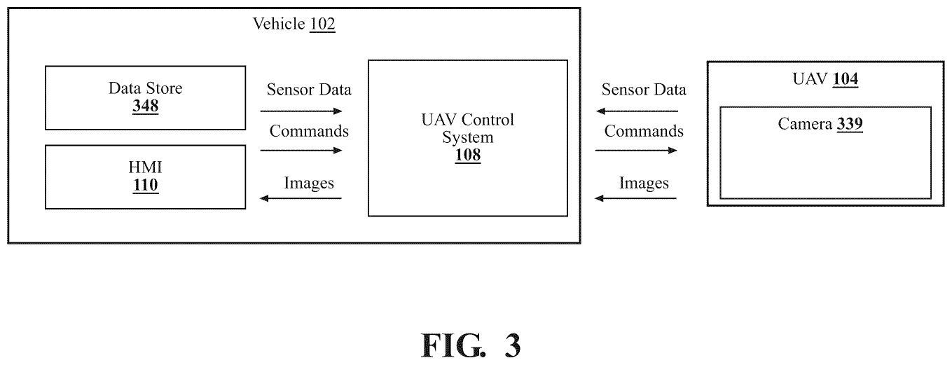

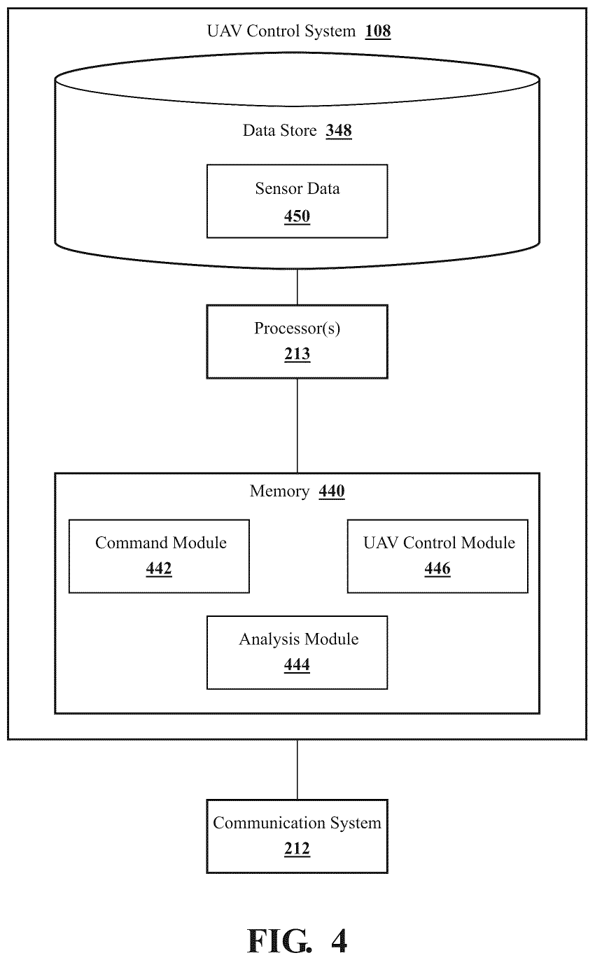

In an example, the UAV control system 108 is disposed within the vehicle 102. Through the UAV control system 108, a passenger/driver within the vehicle 102 may provide commands to the UAV 104 and receive transmitted images from the UAV 104. Accordingly, via the UAV control system 108, the passenger/driver may direct the UAV 104 to a particular location around the vehicle where a target feature of the vehicle 102 may be viewed. That is, the UAV 104 may be wirelessly connected to the vehicle 102 via the UAV control system 108. Additional details regarding the UAV control system 108 and its interaction with the UAV 104 are provided below in connection with FIGS. 3 and 4.

As described below in more detail, the orientation of the UAV 104 and the operating parameters of the UAV camera may be selected based on the pose of the vehicle 102. That is, rather than simply tracking the location of the vehicle 102 and flying relative to the tracked vehicle 102, the UAV 104 position and orientation may be selected based on the angular position of the vehicle (e.g., the vehicle yaw, roll, or pitch) to ensure a desired frame of view of the vehicle 102, the designated region of the vehicle 102, or the target feature of the vehicle 102.

As an example, it may be that a driver desires to view the front axle as the vehicle 102 passes over a potential obstacle (e.g., a boulder 106) on a decline. Without considering the downward pitch of the vehicle 102 and simply tracking the vehicle's location, the UAV 104 may be unable to capture the boulder 106 and/or vehicle axle. Without a clear view of the obstacle, the driver may have difficulty navigating the boulder 106 and the decline. Accordingly, the UAV control system 108 of the present specification determines the pitch of the vehicle 102 and positions the UAV 104 and camera of the UAV 104 based on this pitch to provide a clear view of the obstacle and target feature (e.g., front axle) of the vehicle 102. Note that while particular reference is made to capturing images of an undercarriage, a low-to-the-ground target feature of the vehicle 102, the UAV control system 108 may control the UAV 104 to capture other target features of the vehicle 102. In summary, the UAV control system 108 not only captures images of the vehicle 102 but does so based on the pose of the vehicle 102, the pose being the six degrees of freedom definition of the vehicle 102 location which pose includes an x-position, y-position, z-position, yaw, roll, and pitch.

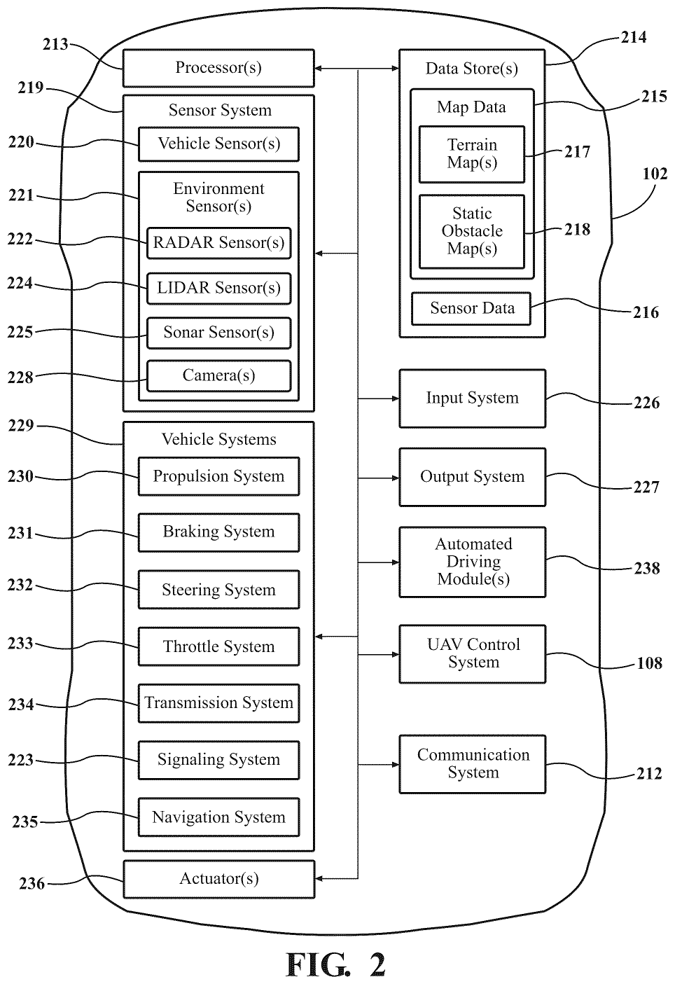

FIG. 2 illustrates one embodiment of a vehicle 102 within which systems and methods disclosed herein may be implemented. As depicted in FIG. 2, the vehicle 102 includes various elements. It will be understood that in various embodiments it may not be necessary for the vehicle 102 to have all of the elements shown in FIG. 2. The vehicle 102 can have different combinations of the various elements shown in FIG. 2. Further, the vehicle 102 can have additional elements to those shown in FIG. 2. In some arrangements, the vehicle 102 may be implemented without one or more of the elements shown in FIG. 2. While the various elements are shown as being located within the vehicle 102 in FIG. 2, it will be understood that one or more of these elements can be located external to the vehicle 102. Further, the elements shown may be physically separated by large distances. For example, as discussed, one or more components of the disclosed system can be implemented within a vehicle while further components of the system are implemented within a cloud-computing environment or other system remote from the vehicle 102.

Some of the possible elements of the vehicle 102 are shown in FIG. 2 and will be described along with subsequent figures. However, a description of many of the elements in FIG. 2 will be provided after the discussion of FIGS. 3-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 102 includes a UAV control system 108 that is implemented to perform methods and other functions as disclosed herein relating to improving the capture of images of a vehicle's exterior surroundings by a UAV 104.

As will be discussed in greater detail subsequently, the UAV control system 108, in various embodiments, is implemented partially within the vehicle 102, and as a cloud-based service. For example, in one approach, functionality associated with at least one module of the UAV control system 108 is implemented within the vehicle 102 while further functionality is implemented within a cloud-based computing system. Thus, the UAV control system 108 may include a local instance at the vehicle 102 and a remote instance that functions within the cloud-based environment.

Moreover, the UAV control system 108, as provided for within the vehicle 102, functions in cooperation with a communication system 212. In one embodiment, the communication system 212 communicates according to one or more communication standards. For example, the communication system 212 can include multiple different antennas/transceivers and/or other hardware elements for communicating at different frequencies and according to respective protocols. The communication system 212, in one arrangement, communicates via a communication protocol, such as a WiFi, DSRC, V2I, V2V, or another suitable protocol for communicating between the vehicle 102 and other entities in the cloud environment such as a UAV 104. Moreover, the communication system 212, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 102 communicating with various remote devices (e.g., a cloud-based server). In any case, the UAV control system 108 can leverage various wireless communication technologies to provide communications to other entities, such as members of the cloud-computing environment.

FIG. 3 illustrates a UAV control system 108 interacting with a UAV 104 and vehicle components to control the UAV 104 to capture vehicle pose-based images of the vehicle 102. As described above, the UAV control system 108 may be disposed within the vehicle 102 and facilitates communication between the UAV 104 and components of the vehicle 102, specifically of the data store 348 and the HMI 110. IN an example, the data store 348 may be the data store 214 depicted in FIG. 2 or may be a separate data store 348 of the UAV control system 108 as depicted in FIG. 4. In either case, the data store 348 may hold sensor data that is relied on by the UAV control system 108. As a specific example, vehicle sensors 220 may be relied on to determine the pose of the vehicle 102, which pose is used to determine how to position and orient the UAV 104 and the UAV camera 339. Similarly, environment sensors 221 may be relied on in part to determine the environment of the vehicle 102 and UAV 104 to identify objects that may be blocking or preventing the UAV camera 339 from capturing images of the vehicle 102 and/or target features of the vehicle 102. This sensor data is passed to the UAV control system 108 which processes such to control the UAV 104.

Similarly, the UAV control system 108 receives sensor data from the UAV 104, which sensor data may be used to perceive the environment and or determine the pose of the vehicle 102. For example, the UAV 104 may include a LiDAR sensor from which obstacles, such as the ground, may be identified and maneuvered around. In an example, the sensor data may include images. In this example, the UAV control system 108 may analyze the images, LiDAR output, or any other environment sensor output to, in part, determine the pose of the vehicle 102. For example, the UAV control system 108 may include an image processor to identify objects in images and the relative position of the objects to other objects in the image. Based on this image analysis, the UAV control system 108 may identify a vehicle 102 in an image and determine its pose within the environment.

The UAV control system 108 also communicates with the HMI 110 of the vehicle 102. That is, the vehicle 102 may include an HMI 110 that acts as an input and output device. A user may input UAV commands through the HMI 110, which may be a touch screen or include buttons. Examples of commands may include navigational commands for the UAV 104. In one particular example, via the HMI 110, a user may select a predetermined position around the vehicle 102 where the UAV 104 is to navigate. In another example, a command may be a camera command, such as to zoom in, to change focus, or to change the angle of the camera 339. These camera commands may allow the user to change the field of view of the camera 339 to focus on a particular object, such as a particular obstacle or a particular region of the vehicle 102. The UAV control system 108 receives these commands, translates or otherwise processes the commands, and transmits such to the UAV 104.

As described above, the UAV control system 108 facilitates the display of images of the vehicle 102 captured by the UAV 104 on a display of the HMI 110. As such, captured images and/or video streams captured by the UAV 104 are received and transmitted to the HMI 110.

Transmission of the sensor data, commands, and images between the UAV control system 108 and the UAV 104 may be facilitated via the communication system 212 described above, which communication system may be a DSRC, Wi-Fi, BLUETOOTH®, or other short-range wireless communication protocol.

FIG. 4 illustrates one embodiment of the UAV control system 108 that is associated with controlling the UAV 104 to capture vehicle pose-based images of the vehicle 102. The UAV control system 108 is shown as including a processor 213 from the vehicle 102 of FIG. 2. Accordingly, the processor 213 may be a part of the UAV control system 108, the UAV control system 108 may include a separate processor from the processor 213 of the vehicle 102, or the UAV control system 108 may access the processor 213 through a data bus or another communication path that is separate from the vehicle 102. In one embodiment, the UAV control system 108 includes a memory 440 that stores a command module 442, an analysis module 444, and a UAV control module 446. The memory 440 is a random-access memory (RAM), read-only memory (ROM), a hard-disk drive, a flash memory, or another suitable memory for storing the modules 442, 444, and 446. The modules 442, 444, and 446 are, for example, computer-readable instructions that when executed by the processor 213 cause the processor 213 to perform the various functions disclosed herein. In alternative arrangements, the modules 442, 444, and 446 are independent elements from the memory 440 that are, for example, comprised of hardware elements. Thus, the modules 442, 444, and 446 are alternatively ASICs, hardware-based controllers, a composition of logic gates, or another hardware-based solution.

Moreover, in one embodiment, the UAV control system 108 includes a data store 348. In an example, the data store 348 is the same as the data store 214 depicted in FIG. 2. In another example the data store 348 may be a separate data store that includes the same or different sensor data 450 as described above.

The data store 348 is, in one embodiment, an electronic data structure stored in the memory 440 or another data storage device and that is configured with routines that can be executed by the processor 213 for analyzing stored data, providing stored data, organizing stored data, and so on. Thus, in one embodiment, the data store 348 stores data used by the modules 442, 444, and 446 in executing various functions.

In general, the data store 348 may store the sensor data 450 relied upon by the UAV control system 108. In an example, the data store 348 includes data from the sensor system 219 of the vehicle 102. From this information, the analysis module 444 may determine the pose of the vehicle 102. That is, the vehicle 102 may include sensors such as an inclinometer, gyroscopes, or other sensors that determine the roll, pitch, and/or yaw of the vehicle 102. As described above, the pose of the vehicle 102 may determine how the UAV 104 is positioned and oriented. As such, the output of these sensors is included in the data store 348 for use by the analysis module 444.

In another example, the sensor data 450 includes data from the environment sensors 221 of the vehicle 102. From this data, the UAV control system 108 may determine objects that may block the visibility of a target feature of the vehicle 102 and/or otherwise alter the flight characteristics of the UAV 104. For example, a canyon wall may be close to the driver's side of the vehicle 102 such that the UAV 104 may not be able to navigate to a selected position along the driver side of the vehicle 102 to capture a side-view image of the rear axle of the vehicle 102. In this example, the sensor data 450 includes environment sensor 221 output detecting this canyon wall such that the UAV control module 446 may direct the UAV 104 to another location to capture an image of the rear axle of the vehicle 102. As another example, the environment sensor 221 output may identify a positive slope in front of the vehicle 102, which may impact the capability of the UAV camera 339 to capture a front view of the vehicle 102. In this example, the UAV control module 446 may re-position the UAV 104 and change a UAV camera 339 angle to facilitate capture of the front of the vehicle 102 notwithstanding the sloped surface.

The sensor data 450 may also include data collected by the UAV 104. That is, the UAV 104 may also be equipped with sensors, the output of which may be used to 1) determine a pose of the vehicle 102 and 2) detect obstacles and terrain features that may alter UAV 104 operation. As an example, the UAV 104 may include a camera 339 that captures images of the vehicle 102. An image processor of the analysis module 444 may identify objects within images, identify their pose, and/or track their movement through a sequence of images or video streams. In this example, the analysis module 444 may identify a vehicle 102 in an image and determine its pose within the surrounding environment. As such, the sensor data 450 may include these images captured by the UAV 104. Like the vehicle 102, the UAV 104 may include environment sensors that detect objects in the vicinity of the UAV 104, objects that may pose a potential collision risk to the UAV 104, or that may block the visibility of the vehicle 102 and/or target feature of the vehicle 102. This information may be stored in the data store 348. While particular reference is made to particular sensors from which a pose of the vehicle 102 is determined and from which a perception of the surrounding environment is made, the sensor data 450 may include the output of other sensors which 1) identify the pose of the vehicle 102 and 2) identify objects in the surrounding environment of the vehicle 102 and the UAV 104. As such, the sensor data 450 may represent a fusion of data from multiple sensors to define the pose of the vehicle 102 more accurately. That is, relying on image analysis alone, the analysis module 444 may make a potentially inaccurate determination of the pose of the vehicle 102. By relying on multiple sets of data, i.e., image analysis (e.g., machine vision) and vehicle sensor data, the analysis module 444 generates a more accurate indication of the vehicle 102 pose.

In one embodiment, the data store 348 stores the sensor data 450 along with, for example, metadata that characterizes various aspects of the sensor data 450. For example, the metadata can include location coordinates (e.g., longitude and latitude), relative map coordinates or tile identifiers, time/date stamps from when the separate sensor data 450 was generated, and so on.

The UAV control system 108 includes a command module 442 which, in one embodiment, includes instructions that cause the processor 213 to receive a selection of a predetermined position around the vehicle 102 for the UAV 104 operatively connected to the vehicle 102. That is, as described above, the UAV 104 is in communication via the communication system 212 with the vehicle 102 such that the UAV 104 may be controlled through an HMI 110 within the vehicle 102. Accordingly, the command module 442 may present an interface through which a command is received from a user.

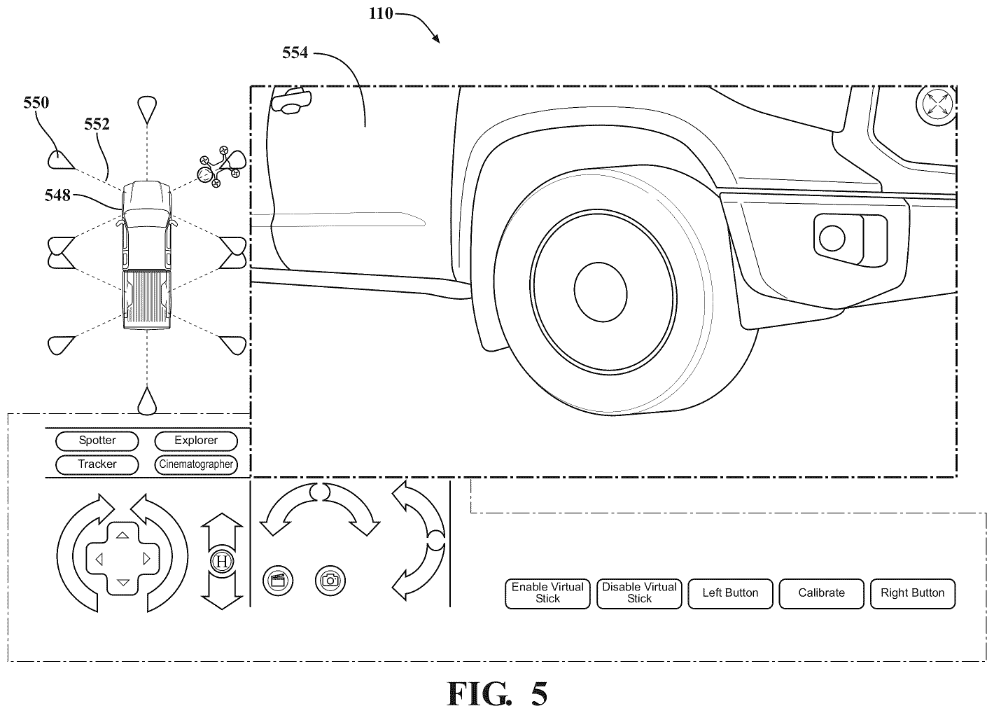

As a particular example, the command module includes instructions that, when executed by the processor 213, cause the processor 213 to present a digital representation of the vehicle 102 on the HMI 110 of the vehicle 102, present digital representations of a set of predetermined positions for the UAV 104 around the digital representation of the vehicle 102, and receive selection of one of the predetermined positions. That is, as depicted below in FIG. 5, the HMI 110 may present indicia of specific locations around the vehicle 102 where the UAV 104 may be placed to capture images and/or video streams of a target feature of the vehicle 102. Thus, rather than manually controlling the UAV 104 to a particular location while also navigating the vehicle 102 across an obstacle, the indicia of predetermined positions allow for a semi-automated control of the UAV 104 to a specific location associated with regularly captured portions of a vehicle 102. In an example, the HMI 110 may be a touch screen such that the command module 442 may interpret contact with the touch screen at a particular position associated with the predetermined position indicia as a command to navigate the UAV 104 to the associated predetermined position.

In an example, the HMI 110 may include other control interfaces. For example, the touch screen may include additional UAV controls such as vertical height adjustment controls, horizontal positioning controls, UAV yaw controls, and camera controls, examples of which are provided below in connection with FIG. 5. In this example, the command module 442 may receive and transmit these commands to the UAV control module 446.

In one example, a user may adjust the distance between the UAV 104 and the vehicle 102 based on a predetermined position. For example, upon selecting a predetermined position to the driver-side front corner of the vehicle 102, a user may desire to have the UAV 104 move closer to the vehicle 102 to provide a closer image of the driver-side front corner of the vehicle 102. In this example, a user may pick a point along an HMI-displayed line between the predetermined position and the vehicle 102 as a new position for the UAV 104. That is, the command module 442 may include instructions to 1) present, on the HMI 110, a digital representation of a bearing angle between a target feature and the UAV 104 at the predetermined position and 2) receive, at the HMI 110, selection of a point along the digital representation of the bearing angle. The UAV control module 446, responsive to this selection, may include instructions that cause the processor 213 to position the UAV 104 at a location associated with a selected point along the digital representation of the bearing angle. An example of this operation and visually displayed bearing angle is provided below in connection with FIG. 5.

The UAV control system 108 includes an analysis module 444 which, in one embodiment, includes instructions that cause the processor 213 to determine the pose of the vehicle 102. As described above, this determination may be made based on sensor data 450 that is collected from the vehicle 102 and/or the UAV 104. For example, a vehicle 102 may include sensors such as gyroscopes, inclinometers, etc., that indicate a roll, pitch, and/or yaw of the vehicle 102. A UAV 104 may include a camera 339 from which images of the vehicle 102 are captured. Based on either of these individually or a fusion of the sensor data, the analysis module 444 may determine the pose of the vehicle 102. For example, the analysis module 444 may include a machine vision image processor that can analyze images, identify objects within an image, and identify the relative position of those objects within an image. For example, the machine vision image processor may be able to infer, estimate, or calculate the pitch of the vehicle 102 from an image of the vehicle 102. This information alone, or when used in conjunction with the vehicle sensor information, allows the analysis module 444 to determine the pose, in three-dimensional space, of the vehicle 102, with the pose including an x-, y-, and z-position of the vehicle as well as a roll, yaw, and pitch of the vehicle 102. In one example, the analysis module 444 may combine (e.g., average, weighted average) the estimated pose of the vehicle 102 as determined from the UAV camera images and the vehicle sensors.

In an example, the analysis module 444 also includes instructions that cause the processor 213 to detect at least a partially obscured field of view of the target feature. As described above, the UAV 104 provides the driver/passenger of the vehicle 102 with a view of the exterior of the vehicle 102. The view may be of a portion of the vehicle 102 not readily visible to the passenger/driver while in the vehicle 102. As a particular example, the view may be of the undercarriage of a vehicle 102 while offroading along terrain filled with boulders 106. However, if the obstacles are obscured, the driver is not afforded a clear view of the path so that they may safely navigate such.

In an example, the detection of an obscured feature of the vehicle 102 may be based on machine vision. That is, the machine vision image processor of the analysis module 444 may identify when a tracked component of the vehicle (e.g., gearbox, axle, wheel, drive train, etc.) of the vehicle is no longer visible, whether blocked by an environmental object such as a rock, tree, etc. or blocked by another portion of the vehicle 102 based on the pose of the vehicle 102. That is, the image processor may identify a feature of the vehicle 102 that is to be tracked. Specifically, each predetermined position indicated on the HMI 110 may pertain to a particular feature to be tracked. For example, predetermined positions about the front of the vehicle 102 may be associated with a front undercarriage of the vehicle 102 such that the UAV 104 is to, using machine vision, identify and track the front undercarriage of the vehicle 102 responsive to a user selection of a predetermined position about the front of the vehicle 102. In this example, the image processor may identify the front undercarriage of the vehicle 102 in an image and determine when the front undercarriage is no longer visible, for example, due to being blocked by another detected obstacle such as a tree, shrub, or rock, or because the front undercarriage is no longer visible due to the undercarriage being blocked by a top surface of the vehicle 102, as may be the case when the vehicle 102 is pitched downward.

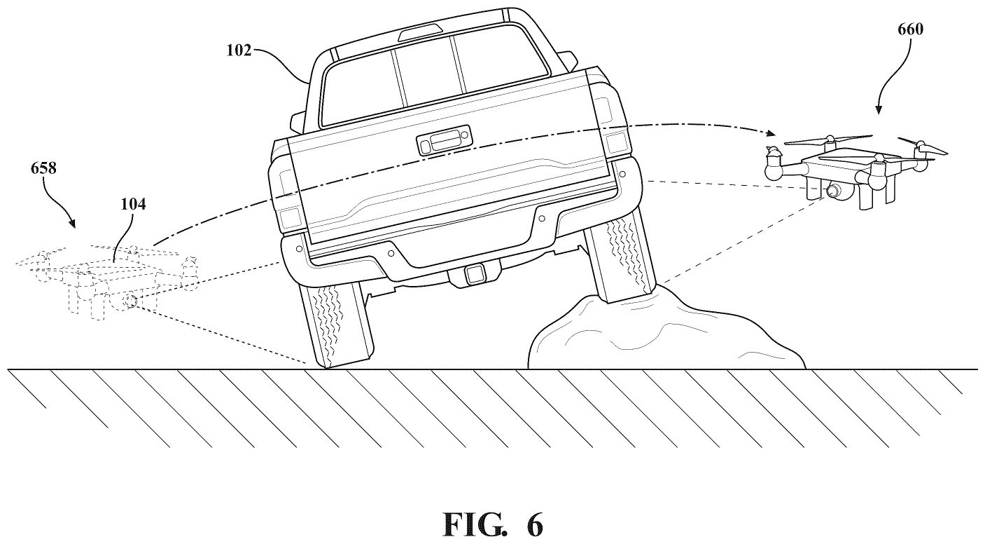

In another example, the analysis module 444 may determine that a particular target feature is obscured from view based on the determined pose of the vehicle 102. For example, suppose a predetermined position is on the driver side of the vehicle 102 is selected so that a side view of the undercarriage of the vehicle 102 is displayed on the HMI 110. In this example, for a given roll angle towards the driver's side, the undercarriage may not be visible from the driver's side. In this example, the analysis module 444 may determine that for an above threshold roll angle towards the driver's side, the undercarriage is not visible when the UAV 104 is on the driver's side of the vehicle 102. An example of this scenario is depicted below in FIG. 6. As another example, when a predetermined position in front of the vehicle 102 is selected and a vehicle pitch angle is greater than a threshold value (e.g., 5 degrees as determined from the vehicle sensors and/or UAV images), the analysis module 444 may infer that the front undercarriage of the vehicle 102 is not within the field of view of the UAV 104.

In an example, the threshold pose values for the vehicle 102 that are used to determine whether a target feature/region of the vehicle 102 is not visible may be based on empirical data or calculated data. In this example, the memory 440 or data store 348 may include, per predetermined position, threshold pose values that allow an inference that the associated target feature is not visible. As such, the analysis module 444 may receive sensor data and image data indicative of the pose of the vehicle 102 and compare the measured pose values of the vehicle 102 to predetermined threshold values for the pose of the vehicle 102. If one or more of the measured values of the pose of the vehicle 102 are outside of a predetermined range, greater than a threshold value, or less than a threshold value, the analysis module 444 may determine that the target feature associated with the predetermined position is not visible within the field of view of the UAV camera 339.

In either case (i.e., sensor-based obscured feature detection or machine vision-based obscured feature detection), the output of the analysis module 444 may be passed to the UAV control module 446 to alter the position of the UAV 104 based on 1) the detected pose of the vehicle and/or 2) a detected obscured target feature of the vehicle 102.

In an example, a target feature of the vehicle 102 may not be readily viewable, not because the target feature is obscured, but because the UAV 104 cannot maneuver into a position to place the target feature in a field of view. For example, to capture an image of an undercarriage of the front end of a vehicle 102, the UAV 104 may navigate close to the ground. If the vehicle 102 is pitched downward, the UAV 104 may be unable to capture an image of the front end of the vehicle 102 while maintaining a safe distance from the ground surface. In this example, the analysis module 444 includes instructions that cause the processor 213 to detect that the UAV 104, at the predetermined position, is within a threshold distance of a ground surface. This output may be transmitted to the UAV control module 446, which may alter the position of the UAV 104.

In one approach, the analysis module 444 implements and/or otherwise uses a machine learning algorithm. In one configuration, the machine learning algorithm is embedded within the analysis module 444, such as a convolutional neural network (CNN). Of course, in further aspects, the analysis module 444 may employ different machine learning algorithms or implement different approaches for performing the pose analysis, which can include deep convolutional encoder-decoder architectures, a multi-scale context aggregation approach using dilated convolutions, or another suitable approach that generates semantic labels for the separate object classes represented in the image. Whichever particular approach the analysis module 444 implements, the analysis module 444 provides an output that indicates a pose of the vehicle 102, and/or a detected obstructed target feature/region of the vehicle 102.

In one or more configurations, the UAV control system 108 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the UAV control system 108 or another system generally trains the machine learning algorithm according to a particular training approach, which may include supervised training, self-supervised training, reinforcement learning, and so on. In contrast to training/learning of the machine learning algorithm, the UAV control system 108 implements the machine learning algorithm to perform inference. Thus, the general use of the machine learning algorithm is described as inference.

The UAV control system 108 includes a UAV control module 446 which, in one embodiment, includes instructions that cause the processor 213 to 1) position the UAV 104 at the predetermined position to capture images of a target feature of the vehicle 102, 2) orient the UAV 104 relative to the vehicle 102 based on the pose of the vehicle 102, and 3) set an operating parameter of a camera 339 of the UAV 104 based on the pose of the vehicle 102. In general, the UAV control module 446 includes instructions that cause the processor 231 to generate commands that are transmitted, via the communication system 212, to the UAV 104. The commands may take a variety of forms, including UAV positional commands, UAV orientation commands, and camera commands.

Specifically, the UAV control module 446 may set the position of the UAV 104 in a horizontal plane based on a selected predetermined position. For example, as depicted in FIG. 5, the HMI 110 may display a digital representation of the vehicle 102 and various predetermined positions around the vehicle 102. Each predetermined position represents a two-dimensional location of the UAV 104 around the vehicle 102. Upon selection of a particular predetermined position, the UAV control module 446 may generate instructions that cause the rotors of the UAV 104 to operate in such a fashion as to direct the UAV 104 to a particular predetermined position associated with the digital representation.

The UAV control module 446 may also orient the UAV 104 based on the predetermined position and/or the pose of the vehicle 102. As a specific example, the UAV control module 446 includes instructions that cause the processor 213 to set at least one of a UAV height, a UAV yaw angle, a UAV lateral position, or a UAV longitudinal position for the UAV 104. For example, it may be that each predetermined position is associated with a particular target feature of the vehicle 102. Different UAV 104 parameters and camera 339 parameters may be associated with each target feature. For example, to capture images of the front tire of the vehicle 102, it may be desirable that the UAV 104 is at a particular height, whereas to capture images of the front undercarriage of the vehicle 102, it may be desirable for the UAV 104 to be at a lower height. Accordingly, based on the predetermined position selected by a user, the UAV control module 446 may control the UAV 104 to hover at a particular height associated with the selected predetermined position.

As another example, the UAV control module 446 may set the yaw of the UAV 104 based on the predetermined position. That is, the yaw of the UAV 104 defines the angular position of the UAV 104 about a vertical axis. The yaw of the UAV 104 may change based on the predetermined position and target region of the vehicle 102 to be captured, as depicted in FIG. 5. Specifically, the yaw of the UAV 104 may be selected such that the camera 339 is directed at the target feature associated with the selected predetermined position.

As another example, the UAV control module 446 may set a relative distance between the UAV 104 and the vehicle 102 based on the selected predetermined position. For example, it may be desirable to have the UAV 104 hover a greater distance away from the vehicle 102 to capture the entire side of the vehicle 102 than when capturing images of the front end of the vehicle 102.

Still further, as described above, the orientation of the UAV 104 may be set based on the pose of the vehicle 102. For example, if the vehicle 102 is rolled to one side, it may be preferred to alter the height of the UAV 104 to adequately capture an image or video stream of the target feature/region of the vehicle 102. For example, if the vehicle 102 has a roll angle such that the passenger side of the vehicle 102 is elevated and the selected predetermined position is on the passenger side of the vehicle 102, it may be desirable to increase the height of the UAV 104 to provide a clear picture of the target feature. An example of this scenario is depicted in FIG. 6 below.

While particular reference is made to particular orientational values (e.g., height, distance, etc.), the UAV control module 446 may set other orientational values for the UAV based on the selected predetermined position for the UAV 104. That is, each predetermined position may map to certain operational parameters, which operational parameters may be empirically determined or set by an administrator or technician and may be stored in the memory 440. In any case, when a particular predetermined position is selected, the UAV control module 446 controls the UAV 104 based on the determined parameters.

As described above, the orientation of the UAV 104 relative to the pose of the vehicle 102 may be determined based on threshold pose values associated with a selected predetermined position and/or machine vision detection of target features of the vehicle 102. In the example described above, if the roll of the vehicle 102 is greater than a threshold amount, the UAV control module 446 may increase the height of the UAV 104. The height of the UAV 104 may be based on the roll angle. In another example, if the machine-vision image processor of the analysis module 444 determines that a target feature is not clearly visible within an image stream, the UAV control module 446 may change the orientation (e.g., height, distance to the vehicle) in an attempt to increase the visibility of the target region/feature.

As described above, the analysis module 444 may determine, based on sensor analysis or machine vision image processing, whether a target feature of the vehicle 102 is appropriately captured based on the current orientation of the UAV 104 and may adjust the orientation of the UAV 104 accordingly. As described above, it may be the case that a particular target feature of the vehicle 102 is obscured based on the pose of the vehicle 102. In this example, the UAV control module 446 includes at least one of 1) instructions to cause the processor 213 to position the UAV 104 at another predetermined position to capture images of the target feature of the vehicle 102 or 2) instructions to cause the processor 213 to generate a recommendation to position the UAV 104 at another predetermined location. Put another way, based on the output of the analysis module 444 that a particular target feature of the vehicle 102 is not being identified in captured images/video streams, the UAV control module 446 takes one of a variety of remedial actions. In one example the UAV control module 446 cycles through other predetermined positions to identify one in which the target feature is readily discernible.

Navigating and selecting another predetermined position may be guided or unguided. In a guided approach, the UAV control module 446 may cycle through predetermined positions associated with the same target feature as the target feature of a user-selected predetermined position. For example, multiple predetermined positions may be associated with a front-end undercarriage target feature. Responsive to an indication that the front-end undercarriage is obscured when viewed from a user-selected predetermined position (whether by another object or a portion of the vehicle 102), the UAV control module 446 may direct the UAV 104 to another predetermined position that is associated with the front-end undercarriage in an attempt to identify a predetermined position from where the UAV 104 may capture clear images of the front-end undercarriage.

In an unguided approach, the UAV control module 446 may cycle through any pattern or sequence of predetermined positions, identify the target feature in the image/video stream and remain at a particular predetermined position where the target feature is visible. In an example, the selection of the subsequent predetermined position may be informed by sensor data. For example, given a selection of a driver-side predetermined position and a roll of the vehicle towards the driver side (i.e., the passenger side wheels are higher than the driver side wheels), the UAV control module 446 may direct the UAV 104 to a predetermined position on the opposite side of the vehicle 102 (i.e., the passenger side) rather than a predetermined position on the front side of the vehicle 102. In another example, the UAV control module 446 may display, on the HMI 110 for example, a notice that the target feature may be obscured and/or a recommendation for a new predetermined position that may provide a more discernible field of view of the target feature.

In an example, similar remedial actions (e.g., positioning the UAV 104 at another predetermined position or generating a notice and/or recommendation for a new UAV 104 position) may be performed responsive to a determination that the UAV 104 is within a threshold distance from the ground.

In another example, the UAV control module 446 may include instructions that cause the processor 213 to alter a UAV position based on user feedback from the HMI 110 in the vehicle 102 while maintaining a bearing angle between the UAV 104 at the predetermined position and the target feature. That is, as described above, it may be that a user desires to zoom in on a particular target feature. In this example, the HMI 110 may present visual indicia of a bearing angle between the target feature and the predetermined position as depicted in FIG. 5. In this example, a user may indicate a point along the visual indicia of the bearing angle and the UAV control module 446 may generate command instructions for the UAV 104 to move closer to the vehicle 102 along the bearing angle so as to zoom in on the target feature. An example of this is provided below in connection with FIG. 5.

In addition to setting flight parameters (e.g., position and orientation) for the UAV 104, the UAV control module 446 also controls the operating parameters of the camera 339. Example operating parameters include, but are not limited to a camera angle, a camera focal point, or a camera zoom level. As with the UAV 104 position and orientation, each predetermined position may be associated with particular operating parameters for a camera 339, which are selected to provide discernible images of a target feature and may be set by a manufacturer or administrator. For example, when capturing images of a passenger side front wheel, it may be desirable for the UAV 104 to hover at a predetermined height and for the camera gimbal to be set to a predetermined angle. In this example, based on a selected predetermined position, the UAV control module 446 may select the predetermined camera gimbal angle. While particular reference is made to particular operational parameter settings, the UAV control module 446 may set any variety of operational parameters based on a predetermined position at which the UAV 104 is located.

FIG. 5 illustrates one embodiment of a human-machine interface (HMI) 110 of the vehicle 102 to control the UAV 104. As described above, the HMI 110 is an interface through which a user may provide commands to the UAV 104 and through which images captured by the UAV 104 are presented to the passengers of the vehicle 102. Accordingly, as depicted in FIG. 5, the HMI 110 includes a display portion 554 on which images or video streams of the UAV 104 are visually presented to a user. As described above, in an example, the orientation associated with a predetermined position may be within a threshold distance of a ground surface to capture images of an undercarriage of the vehicle102. That is, during off-roading, a driver may be particularly interested to know the state of the undercarriage and objects that may potentially strike and damage the undercarriage. As such, the selection of a predetermined position may be within a threshold distance of the ground surface, which predetermined position may be below a minimum hover height for the UAV 104. In this example, the UAV control module 446 may disable or alter the minimum hover height such that the UAV 104 may be at a low enough elevation to capture the undercarriage. In an example, the threshold distance may be between 0.5 feet (ft) and 2 ft.

The HMI 110 may also include a command portion wherein a user inputs commands for the UAV 104. As depicted and described, the HMI 110 may present a vehicle digital representation 548 and predetermined position digital representations 550. For simplicity, a single predetermined position digital representation 550 is indicated with a reference number. By selecting one of the predetermined position digital representations 550, a user selects a real-world position for the UAV 104. When in a selected predetermined position, the angle of the camera 339 and the position of the UAV 104 are preconfigured to capture specific regions of the vehicle 102.

As described above and as depicted in FIG. 5, multiple predetermined positions may be associated with a particular target feature of the vehicle 102. In the example depicted in FIG. 5, the front five predetermined positions may be associated with a front-end undercarriage of the vehicle 102, while the rear five predetermined positions may be associated with a rear-end undercarriage of the vehicle 102. When the UAV 104 is directed to any predetermined position, the UAV control module 446 may orient the UAV 104 and the camera 339 to capture the respective target feature (i.e., the front-end undercarriage and the rear-end undercarriage).

Note that different predetermined positions associated with a particular target feature are associated with different fields of view of the target feature. That is, when at a first predetermined position (e.g., associated with the front-end undercarriage of the vehicle 102), the camera 339 of the UAV 104 captures images of the target feature from a first angle, while when at a second predetermined position (e.g., associated with the same target feature), the camera 339 of the UAV 104 captures images of the target feature form a second angle. Accordingly, when the target feature is obscured when the UAV 104 is at one particular predetermined position associated with a target feature, the UAV control module 446 may control the UAV 104 to different predetermined positions associated with the target feature, whether in a guided or unguided fashion.

Also as described above, the HMI 110 may present a bearing angle digital representation 552, which bearing angle represents the angle between the predetermined position and the target feature of the vehicle 102 that is associated with the predetermined position. For simplicity in illustration, a single bearing angle digital representation 552 is indicated with a reference number. As described above, users may select any point along the bearing angle. Following this selection, the UAV control module 446 moves the UAV 104 along that bearing angle while maintaining the bearing angle. Specifically, the command module 442 includes instructions that cause the processor 213 to alter a UAV position based on user feedback received from the HMI 110 in the vehicle 102 while maintaining a bearing angle between the UAV 104 at the predetermined position and the target feature. This functionality allows the operator to increase the zoom level of the image/stream of the target feature.

In an example, the HMI 110 displays other command elements as well. Through these command elements, the operator may control various flight functions of the UAV 104 as well as the operating parameters of the camera 339. Example command functions include selecting a mode for the UAV 104, selecting the yaw of the UAV 104, selecting the height of the UAV 104, selecting the gimbal roll and pitch angles for the camera 339, and a command to capture a still image from the camera 339 stream. Note that while FIG. 5 depicts particular commands, other commands may be included. Moreover, while FIG. 5 depicts a particular visual format (i.e., a top view of the vehicle with particularly shaped predetermined position digital representations 550), different visual presentations may be provided, such as a 3D model of the vehicle 102 that may be manipulated via on-screen gestures.

FIG. 6 illustrates one embodiment of the UAV control system 108 controlling the UAV 104 to capture vehicle pose-based images of the vehicle 102. As described above, it may be that the UAV 104 is directed to a first predetermined position 658 on the driver side of the vehicle 102 to capture images of the undercarriage of the vehicle 102. However, as described above, based on the pose of the vehicle 102, any captured image may not adequately depict the target feature (e.g., the undercarriage). Such a determination may be based on a machine-vision analysis (i.e., that the tracked object is not found in frames of the captured images or is blocked by another object and/or the vehicle 102 itself) or a sensor-based analysis (i.e., the vehicle 102 has a roll angle past a particular threshold). In another example, while in the first predetermined position 658, the command module 442 may determine that the UAV 104 is too close to the ground. In either case, the UAV control system 108, either automatically or semi-automatically (i.e., following authorization from a user), may navigate to another predetermined position 660 where the undercarriage may be more readily viewed.

In an example, the UAV control module 446 includes instructions that cause the processor 213 to transmit captured images of the vehicle 102 to a display of the vehicle 102. Accordingly, the present UAV control system 108 captures images of a vehicle 102, and specifically of target features of a vehicle 102, and transmits images to the HMI 110 such that a driver is afforded additional visual information through which they can navigate the vehicle 102 across uneven terrain. A UAV-based vehicle image capture system that does not account for the pose of the vehicle 102 may provide ineffective images to the driver as object visibility in images is impacted by the pose (e.g., roll, yaw, and pitch) of the vehicle 102 within the image.

Note that while in the second predetermined position 660, the UAV 104 is higher in elevation. This may be on account of the pose of the vehicle 102. That is, as the vehicle 102 is tilted, a higher elevation with the camera 339 pointing down may provide a greater view of the undercarriage of the vehicle 102.

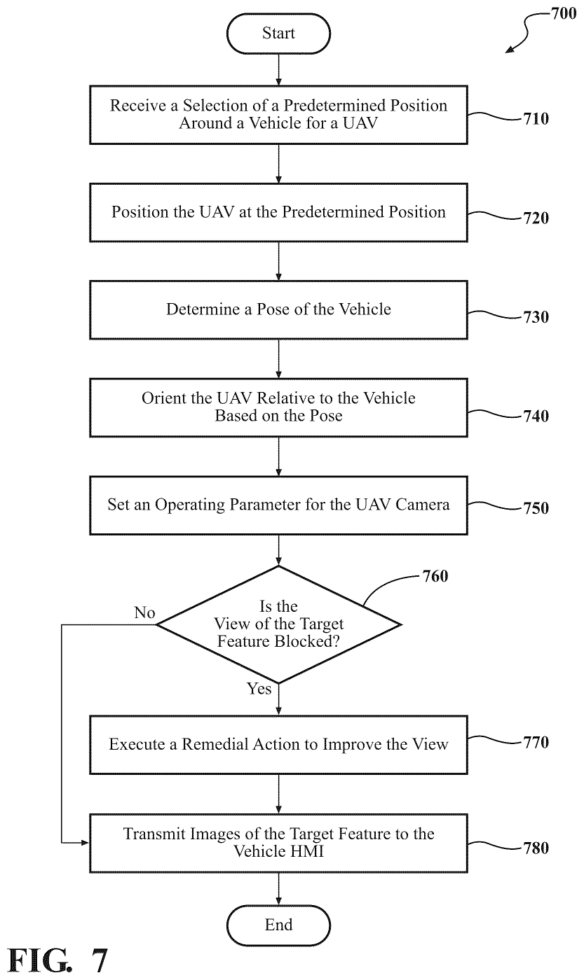

Additional aspects of capturing images of a vehicle 102 from a UAV 104 will be discussed in relation to FIG. 7. FIG. 7 illustrates a flowchart of a method 700 that is associated with capturing vehicle images based on a pose of the vehicle 102. Method 700 will be discussed from the perspective of the UAV control system 108 of FIGS. 1-4. While method 700 is discussed in combination with the UAV control system 108, it should be appreciated that the method 700 is not limited to being implemented within the UAV control system 108 but is instead one example of a system that may implement the method 700.

At 710, the UAV control system 108, and more particularly the command module 442 receives a selection of a predetermined position around the vehicle 102 to which a UAV 104 will be directed to capture an image of the vehicle exterior. As described above, this may be via the HMI 110 wherein a user selects a touchscreen predetermined position digital representation 550, however other modalities may be implemented in accordance with the principles described herein.

At 720, the UAV control system 108, and more particularly the UAV control module 446, positions the UAV 104 at the predetermined position. That is, the UAV control module 446 generates control signals that operate the rotors or other propulsion devices of the UAV 104 to move and maintain the UAV 104 at a predetermined position mapped to the predetermined position digital representation 550.

At 730, the UAV control system 108, and more particularly the analysis module 444, determines the pose of the vehicle 102. As described above, the pose of the vehicle 102 defines the orientation and position of the vehicle 102 in six degrees (i.e., x position, y position, z position, roll, yaw, and pitch). This may be based on machine vision image processing, vehicle sensor data, or a fusion of machine vision image processing and vehicle sensor data. As described above, knowing the pose of the vehicle 102 allows the UAV control system 108 to position the UAV 104 at a location and orientation to ensure clear and unobstructed images of the target feature of the vehicle 102.

At 740, the UAV control system 108, and more particularly the UAV control module 446, orients the UAV 104 relative to the vehicle 102 based on the pose. As an example, the UAV control module 446 may elevate or lower the UAV 104 based on the pose of the vehicle 102. As a particular example, if a vehicle 102 is rolled towards the driver-side as depicted in FIG. 5, the UAV control module 446 may lower the UAV 104 in the first predetermined position 658 to capture the undercarriage of the vehicle 102. In another example, the UAV control module 446 may elevate the UAV 104 in the second predetermined position 660 to capture the undercarriage of the vehicle 102.

In an example, the UAV 104 orientation adjustment may be based on the pose values measured by the vehicle sensors. That is, the analysis module 444 may include a mapping between pose values and adjustments to the UAV 104 orientation. As described above, as one particular example, a particular roll angle of the vehicle 102 may be mapped to a particular elevation of the UAV 104 above the ground surface. These and other mappings may be determined based on machine learning and/or empirical investigation.

In another example, the adjustment to the UAV 104 orientation may be based on the machine vision image processing of UAV images. For example, the orientation of the UAV 104 (e.g., the height, yaw, etc.) may be adjusted in a trial-and-error fashion or a guided machine-learning fashion until the machine vision image processor identifies the object in the images.

At 750, the UAV control system 108, and more particularly the UAV control module 446, may set an operating parameter for the UAV camera 339. That is, based on the location of the UAV 104 relative to the vehicle 102 and the target feature to be captured, the UAV control module 446 may implement certain parameters to provide targeted capturing parameters for the target feature.

At 760, the UAV control system 108, and more particularly the command module 442, may determine if the view of the target feature is blocked. Again as described above, this may be based on machine vision image processing and/or vehicle sensors. If not blocked, at 780, the UAV control system 108, and more particularly the UAV control module 446, transmits images of the target feature to the vehicle HMI 110. If the view of the target feature is blocked, at 770, the UAV control system 108, and more particularly the UAV control module 446, executes a remedial action to improve the view, which remedial action may include automatically moving the UAV 104 to a different predetermined position and/or providing a notification to the operator of the blockage and/or a recommendation to move the UAV 104 to a different location.

As such, the present UAV control system 108 ensures clear images/streams of selected target features of a vehicle 102 and its exterior surroundings, all while accounting for the vehicle 102 pose, which, if unaccounted for, could render images/streams unclear.

FIG. 2 will now be discussed in full detail as an example environment within which the system and methods disclosed herein may operate. In some instances, the vehicle 102 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 102 as manipulated by a user (e.g., human driver). In one or more arrangements, the vehicle 102 can be a manually-controlled vehicle that is configured to operate in only the manual mode.

In one or more arrangements, the vehicle 102 implements some level of automation in order to operate autonomously or semi-autonomously. As used herein, automated control of the vehicle 102 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 102 along a travel route via a computing system to control the vehicle 102 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 102.

With continued reference to the various components illustrated in FIG. 2, the vehicle 102 includes one or more processors 213. In one or more arrangements, the processor(s) 213 can be a primary/centralized processor of the vehicle 102 or may be representative of many distributed processing units. For instance, the processor(s) 213 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 102.

The vehicle 102 can include one or more data stores 214 for storing one or more types of data. The data store 214 can be comprised of volatile and/or non-volatile memory. Examples of memory that may form the data store 214 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 214 is a component of the processor(s) 213. In general, the data store 214 is operatively connected to the processor(s) 213 for use thereby. The term “operatively connected,” as used throughout this description, can include direct or indirect connections, including connections without direct physical contact.

In one or more arrangements, the one or more data stores 214 include various data elements to support functions of the vehicle 102, such as semi-autonomous and/or autonomous functions. Thus, the data store 214 may store map data 215 and/or sensor data 216. The map data 215 includes, in at least one approach, maps of one or more geographic areas. In some instances, the map data 215 can include information about roads (e.g., lane and/or road maps), traffic control devices, road markings, structures, features, and/or landmarks in the one or more geographic areas. The map data 215 may be characterized, in at least one approach, as a high-definition (HD) map that provides information for autonomous and/or semi-autonomous functions.

In one or more arrangements, the map data 215 can include one or more terrain maps 217. The terrain map(s) 217 can include information about the ground, terrain, roads, surfaces, and/or other features of one or more geographic areas. The terrain map(s) 217 can include elevation data in the one or more geographic areas. In one or more arrangements, the map data 215 includes one or more static obstacle maps 218. The static obstacle map(s) 218 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 216 is data provided from one or more sensors of the sensor system 219. Thus, the sensor data 216 may include observations of a surrounding environment of the vehicle 102 and/or information about the vehicle 102 itself. In some instances, one or more data stores 214 located onboard the vehicle 102 store at least a portion of the map data 215 and/or the sensor data 216. Alternatively, or in addition, at least a portion of the map data 215 and/or the sensor data 216 can be located in one or more data stores 214 that are located remotely from the vehicle 102.

As noted above, the vehicle 102 can include the sensor system 219. The sensor system 219 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 219 and/or the one or more sensors can be operatively connected to the processor(s) 213, the data store(s) 214, and/or another element of the vehicle 102.

Various examples of different types of sensors will be described herein. However, it will be understood that the embodiments are not limited to the particular sensors described. In various configurations, the sensor system 219 includes one or more vehicle sensors 220 and/or one or more environment sensors. The vehicle sensor(s) 220 function to sense information about the vehicle 102 itself. In one or more arrangements, the vehicle sensor(s) 220 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 102.

As noted, the sensor system 219 can include one or more environment sensors 221 that sense a surrounding environment (e.g., external) of the vehicle 102 and/or, in at least one arrangement, an environment of a passenger cabin of the vehicle 102. For example, the one or more environment sensors 221 sense objects the surrounding environment of the vehicle 102. Such obstacles may be stationary objects and/or dynamic objects. Various examples of sensors of the sensor system 219 will be described herein. The example sensors may be part of the one or more environment sensors 221 and/or the one or more vehicle sensors 220. However, it will be understood that the embodiments are not limited to the particular sensors described. As an example, in one or more arrangements, the sensor system 219 includes one or more radar sensors 222, one or more LIDAR sensors 224, one or more sonar sensors 225 (e.g., ultrasonic sensors), and/or one or more cameras 228 (e.g., monocular, stereoscopic, RGB, infrared, etc.).

Continuing with the discussion of elements from FIG. 1, the vehicle 102 can include an input system 226. The input system 226 generally encompasses one or more devices that enable the acquisition of information by a machine from an outside source, such as an operator. The input system 226 can receive an input from a vehicle passenger (e.g., a driver/operator and/or a passenger). Additionally, in at least one configuration, the vehicle 102 includes an output system 227. The output system 227 includes, for example, one or more devices that enable information/data to be provided to external targets (e.g., a person, a vehicle passenger, another vehicle, another electronic device, etc.).

Furthermore, the vehicle 102 includes, in various arrangements, one or more vehicle systems 229. Various examples of the one or more vehicle systems 229 are shown in FIG. 2. However, the vehicle 102 can include a different arrangement of vehicle systems. It should be appreciated that although particular vehicle systems are separately defined, each or any of the systems or portions thereof may be otherwise combined or segregated via hardware and/or software within the vehicle 102. As illustrated, the vehicle 102 includes a propulsion system 230, a braking system 231, a steering system 232, a throttle system 233, a transmission system 234, a signaling system 223, and a navigation system 235.

The navigation system 235 can include one or more devices, applications, and/or combinations thereof to determine the geographic location of the vehicle 102 and/or to determine a travel route for the vehicle 102. The navigation system 235 can include one or more mapping applications to determine a travel route for the vehicle 102 according to, for example, the map data 215. The navigation system 235 may include or at least provide connection to a global positioning system, a local positioning system or a geolocation system.

In one or more configurations, the vehicle systems 229 function cooperatively with other components of the vehicle 102. For example, the processor(s) 213 and/or automated driving module(s) 238 can be operatively connected to communicate with the various vehicle systems 229 and/or individual components thereof. For example, the processor(s) 213 and/or the automated driving module(s) 238 can be in communication to send and/or receive information from the various vehicle systems 229 to control the navigation and/or maneuvering of the vehicle 102. The processor(s) 213 and/or the automated driving module(s) 238 may control some or all of these vehicle systems 229.

For example, when operating in the autonomous mode, the processor(s) 213 and/or the automated driving module(s) 238 control the heading and speed of the vehicle 102. The processor(s) 213 and/or the automated driving module(s) 238 cause the vehicle 102 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 102 includes one or more actuators 236 in at least one configuration. The actuators 236 are, for example, elements operable to move and/or control a mechanism, such as one or more of the vehicle systems 229 or components thereof responsive to electronic signals or other inputs from the processor(s) 213 and/or the automated driving module(s) 238. The one or more actuators 236 may include motors, pneumatic actuators, hydraulic pistons, relays, solenoids, piezoelectric actuators, and/or another form of actuator that generates the desired control.

As described previously, the vehicle 102 can include one or more modules, at least some of which are described herein. In at least one arrangement, the modules are implemented as non-transitory computer-readable instructions that, when executed by the processor 213, implement one or more of the various functions described herein. In various arrangements, one or more of the modules are a component of the processor(s) 213, or one or more of the modules are executed on and/or distributed among other processing systems to which the processor(s) 213 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 102 may include one or more automated driving modules 238. The automated driving module(s) 238, in at least one approach, receive data from the sensor system 219 and/or other systems associated with the vehicle 102. In one or more arrangements, the automated driving module(s) 238 use such data to perceive a surrounding environment of the vehicle. The automated driving module(s) 238 determine a position of the vehicle 102 in the surrounding environment and map aspects of the surrounding environment. For example, the automated driving module(s) 238 determines the location of obstacles or other environmental features including traffic signs, trees, shrubs, neighboring vehicles, pedestrians, etc.

The automated driving module(s) 238 can be configured to determine travel path(s), current autonomous driving maneuvers for the vehicle 102, future autonomous driving maneuvers and/or modifications to current autonomous driving maneuvers based on data acquired by the sensor system 219 and/or another source. In general, the automated driving module(s) 238 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
receive a selection of a predetermined position around a vehicle for an unmanned aerial vehicle (UAV) operatively connected to the vehicle;
position the UAV at the predetermined position to capture images of a target feature of the vehicle;
determine a pose of the vehicle;
orient the UAV relative to the vehicle based on the pose of the vehicle; and
set an operating parameter of a camera of the UAV based on the pose of the vehicle.

2. The system of claim 1, wherein the machine-readable instructions to receive the selection of the predetermined position for the UAV comprises a machine-readable instruction that, when executed by the processor, causes the processor to receive a selection of a predetermined position that is within a threshold distance of a ground surface to capture images of an undercarriage of the vehicle.

3. The system of claim 1, wherein the machine-readable instructions further comprise machine-readable instructions that, when executed by the processor, cause the processor to transmit captured images of the vehicle to a display of the vehicle.

4. The system of claim 1, wherein:
when at a first predetermined position, the camera of the UAV captures the images of the target feature from a first angle; and
when at a second predetermined position, the camera of the UAV captures the images of the target feature from a second angle.

5. The system of claim 1, wherein the machine-readable instructions further comprise:
a machine-readable instruction that, when executed by the processor, causes the processor to detect at least a partially obscured field of view of the target feature; and
at least one of:
a machine-readable instruction that, when executed by the processor, causes the processor to position the UAV at another predetermined position to capture images of the target feature of the vehicle; or
a machine-readable instruction that, when executed by the processor, causes the processor to generate a recommendation to position the UAV at another predetermined position to capture images of the target feature of the vehicle.

6. The system of claim 1, wherein the machine-readable instructions further comprise:
a machine-readable instruction that, when executed by the processor, causes the processor to detect that the UAV, at the predetermined position, is within a threshold distance of a ground surface; and
at least one of:
a machine-readable instruction that, when executed by the processor, causes the processor to position the UAV at another predetermined position to capture images of the target feature of the vehicle; or
a machine-readable instruction that, when executed by the processor, causes the processor to generate a recommendation to position the UAV at another predetermined position to capture images of the target feature of the vehicle.

7. The system of claim 1, wherein the machine-readable instructions further comprise machine-readable instructions that, when executed by the processor, cause the processor to:
present a digital representation of the vehicle on a human-machine interface (HMI) in the vehicle;
present digital representations of a set of predetermined positions for the UAV around the digital representation on the HMI; and
receive the selection of the predetermined position from the digital representations of the set of predetermined positions.

8. The system of claim 1, wherein:
the machine-readable instruction that, when executed by the processor, causes the processor to orient the UAV relative to the vehicle comprises a machine-readable instruction that, when executed by the processor, causes the processor to set at least one of a UAV height, a UAV yaw angle, a UAV lateral position, or a UAV longitudinal position; and
the machine-readable instruction that, when executed by the processor, causes the processor to set the operating parameter for the camera of the UAV comprises a machine-readable instruction that, when executed by the processor, causes the processor to set at least one of a camera angle, a camera focal point, or a camera zoom level for the camera of the UAV.

9. The system of claim 1, wherein the machine-readable instructions further comprise a machine-readable instruction that, when executed by the processor, causes the processor to alter a UAV position based on user feedback received from a human-machine interface (HMI) in the vehicle while maintaining a bearing angle between the UAV at the predetermined position and the target feature.

10. The system of claim 1, wherein the machine-readable instructions further comprise machine-readable instructions that, when executed by the processor, cause the processor to:
present, on a human-machine interface (HMI) in the vehicle, a digital representation of a bearing angle between the target feature and the UAV at the predetermined position;
receive, at the HMI, a selection of a point along the digital representation of the bearing angle; and
position the UAV at a location associated with a selected point along the digital representation of the bearing angle.

11. A non-transitory machine-readable medium comprising instructions that, when executed by a processor, cause the processor to:
receive a selection of a predetermined position around a vehicle for an unmanned aerial vehicle (UAV) operatively connected to the vehicle;
position the UAV at the predetermined position to capture images of a target feature of the vehicle;
determine a pose of the vehicle;
orient the UAV relative to the vehicle based on the pose of the vehicle; and
set an operating parameter of a camera of the UAV based on the pose of the vehicle.

12. The non-transitory machine-readable medium of claim 11, wherein the instruction to receive the selection of the predetermined position for the UAV comprises an instruction that, when executed by the processor, causes the processor to receive a selection of a predetermined position that is within a threshold distance of a ground surface to captures images of an undercarriage of the vehicle.

13. The non-transitory machine-readable medium of claim 11, wherein the instructions further comprise:
an instruction that, when executed by the processor, causes the processor to detect at least a partially obscured field of view of the target feature; and
at least one of:
an instruction that, when executed by the processor, causes the processor to position the UAV at another predetermined position to capture images of the target feature of the vehicle; or
an instruction that, when executed by the processor, causes the processor to generate a recommendation to position the UAV at another predetermined position to capture images of the target feature of the vehicle.

14. The non-transitory machine-readable medium of claim 11, wherein the instructions further comprise:
an instruction that, when executed by the processor, causes the processor to detect that the UAV, at the predetermined position, is within a threshold distance of a ground surface; and
at least one of:
an instruction that, when executed by the processor, causes the processor to position the UAV at another predetermined position to capture images of the target feature of the vehicle; or
an instruction that, when executed by the processor, causes the processor to generate a recommendation to position the UAV at another predetermined position to capture images of the target feature of the vehicle.

15. The non-transitory machine-readable medium of claim 11, wherein the instructions further comprise instructions that, when executed by the processor, cause the processor to:
present a digital representation of the vehicle, a set of predetermined positions for the UAV, and bearing angles between the predetermined positions and the target feature on a human-machine interface (HMI) in the vehicle;
receive, at the HMI, the selection of the predetermined position from the digital representations of the set of predetermined positions; and
position the UAV at a location associated with a selected point along the digital representation of a bearing angle.

16. A method, comprising:
receiving a selection of a predetermined position around a vehicle for an unmanned aerial vehicle (UAV) operatively connected to the vehicle;
positioning the UAV at the predetermined position to capture images of a target feature of the vehicle;
determining a pose of the vehicle;
orienting the UAV relative to the vehicle based on the pose of the vehicle; and
setting an operating parameter of a camera of the UAV based on the pose of the vehicle.

17. The method of claim 16, wherein receiving the selection of the predetermined position for the UAV comprises receiving a selection of a predetermined position that is within a threshold distance of a ground surface to capture images of an undercarriage of the vehicle.

18. The method of claim 16, further comprising:
detecting at least a partially obscured field of view of the target feature; and
at least one of:
positioning the UAV at another predetermined position to capture images of the target feature of the vehicle; or
generating a recommendation to position the UAV at another predetermined position to capture images of the target feature of the vehicle.

19. The method of claim 16, further comprising:
detecting that the UAV, at the predetermined position, is within a threshold distance of a ground surface; and
at least one of:
positioning the UAV at another predetermined position to capture images of the target feature of the vehicle; or
generating a recommendation to position the UAV at another predetermined position to capture images of the target feature of the vehicle.

20. The method of claim 16, further comprising:
presenting a digital representation of the vehicle, a set of predetermined positions for the UAV, and bearing angles between the predetermined positions and the target feature on a human-machine interface (HMI) in the vehicle;
receiving, at the HMI, selection of the predetermined position from the digital representations of the set of predetermined positions; and
positioning the UAV at a location associated with a selected point along the digital representation of the bearing angle.
